(19) United States
(12) Patent Application Publication
(10) Pub. No.: US 2026/0024482 A1
(43) Pub. Date: Jan. 22, 2026

(54) PIXEL CIRCUIT, DISPLAY PANEL, AND DISPLAY DEVICE

(71) Applicant: Wuhan Tianma Micro electronics Co., Ltd., Wuhan (CN)

(72) Inventor: Shu ZHOU, Wuhan (CN)

(73) Assignee: Wuhan Tianma Micro electronics Co., Ltd., Wuhan (CN)

(21) Appl. No.: 18/918,120

(22) Filed: Oct. 17, 2024

(30) Foreign Application Priority Data
Jul. 19, 2024 (CN) 202410978437.6

(51) Int. Cl. G09G 3/32

(52) U.S. Cl. CPC G09G 3/32; G09G 2310/061; G09G 2310/08; G09G 2320/0233; G09G 2320/0247; G09G 2330/021

(57) ABSTRACT

The present application discloses a pixel circuit, display panel and display device f. The pixel circuit includes a driving module, a first reset module, and a light-emitting element. The driving module includes a driver transistor. A driving cycle of the pixel circuit includes a data writing frame, the data writing frame includes a non-light-emitting phase and a light-emitting phase, and the non-light-emitting phase includes a first reset phase. The drive module is configured to drive the light-emitting element to emit light in the light-emitting phase, and the first reset module is configured to simultaneously reset a gate, a first electrode, and a second electrode of the driver transistor in the first reset phase.

### CROSS-REFERENCE TO RELATED APPLICATION

This application claims priority to Chinese Patent Application No. 202410978437.6, filed on Jul. 19, 2024, which is hereby incorporated by reference in its entirety.

### TECHNICAL FIELD

The present application relates to the technical field of display, and in particular to a pixel circuit, display panel and display device.

### BACKGROUND

With the continuous improvement of the display technology of the display panel, people have higher and higher requirements for the display quality of the display panel. At present, the light-emitting components in the display panel have problems such as unstable light emission, flickering and residual shadow, which will cause the display effect of the display panel to be greatly reduced.

### SUMMARY

Embodiments of the present application provide a pixel circuit, display panel and display device which can avoid the potential of the gate of the driver transistor from being affected by the potential in a previous frame, and thus improve the brightness variation and flickering phenomenon of a light-emitting element when driven at a low frequency. At the same time, the effect of characteristic offset or hysteresis of the driver transistor after a long period of time of operation is improved, the conduction bias stress of the driver transistor is enhanced, and the display quality when driven at a low frequency is improved.

In a first aspect, embodiments of the present application provide a pixel circuit including a driving module, a first reset module, and a light-emitting element. The driving module includes a driver transistor. A driving cycle of the pixel circuit includes a data writing frame, the data writing frame includes a non-light-emitting phase and a light-emitting phase, and the non-light-emitting phase includes a first reset phase. The drive module is configured to drive the light-emitting element to emit light in the light-emitting phase, and the first reset module is configured to simultaneously reset a gate of the driver transistor, a first electrode of the driver transistor and a second electrode of the driver transistor in the first reset phase.

In a second aspect, embodiments of the present application provide a display panel comprising a pixel circuit as described in the first aspect.

In a third aspect, embodiments of the present application provide a display device comprising a display panel as described in the second aspect.

### BRIEF DESCRIPTION OF THE DRAWINGS

FIG. 1 is a schematic view of a pixel circuit according to an embodiment of the present application.

FIG. 2 is a schematic view of another pixel circuit according to an embodiment of the present application.

FIG. 3 is a timing diagram of FIG. 2.

FIG. 4 is a schematic view of another pixel circuit according to an embodiment of the present application.

FIG. 5 is a schematic view of yet another pixel circuit according to an embodiment of the present application.

FIG. 6 is a timing diagram of FIG. 5.

FIG. 7 is a schematic view of another pixel circuit according to an embodiment of the present application.

FIG. 8 is a schematic view of still another pixel circuit according to an embodiment of the present application.

FIG. 9 is a timing diagram of FIG. 8.

FIG. 10 is a schematic view of yet another pixel circuit according to an embodiment of the present application.

FIG. 11 is a timing diagram of FIG. 10.

FIG. 12 is a schematic view of yet another pixel circuit according to an embodiment of the present application.

FIG. 13 is a timing diagram of FIG. 12.

FIG. 14 is a schematic view of yet another pixel circuit according to an embodiment of the present application.

FIG. 15 is a schematic view of yet another pixel circuit according to an embodiment of the present application.

FIG. 16 is a schematic view of yet another pixel circuit according to an embodiment of the present application.

FIG. 17 is a timing diagram of FIG. 16.

FIG. 18 is a schematic view of yet another pixel circuit according to an embodiment of the present application.

FIG. 19 is a schematic view of a display panel according to an embodiment of the present application.

FIG. 20 is a schematic view of a display device according to an embodiment of the present application.

### DETAILED DESCRIPTION

In order to make the objects, technical scheme and advantages of the present application clearer, the technical solutions of the present application will be clearly and completely described hereinafter by way of embodiments with reference to the accompanying drawings in the embodiments of the present application, and it is clear that the embodiments described are a part of the embodiments of the present application and not all of the embodiments. Based on the basic concepts revealed and suggested by the embodiments in the present application, all other embodiments obtained by those skilled in the art fall within the scope of protection of the present application.

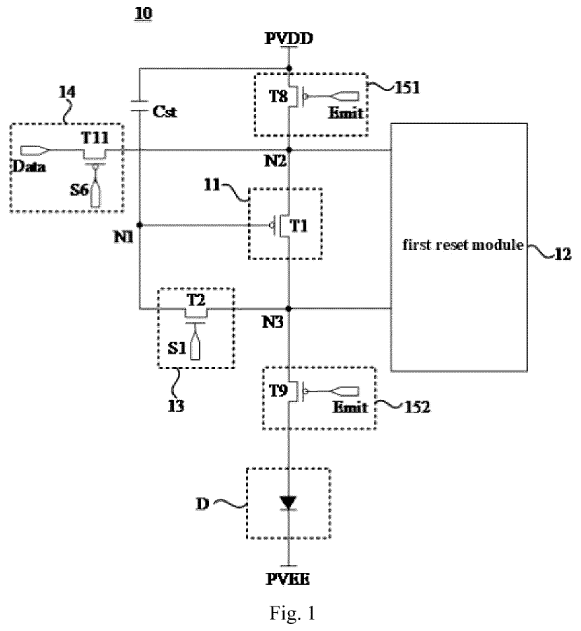

FIG. 1 is a schematic view of a pixel circuit according to an embodiment of the present application. Referring to FIG. 1, the pixel circuit 10 includes a driving module 11, a first reset module 12, and a light-emitting element D. A driving cycle of the pixel circuit 10 includes a data writing frame F1, and the data writing frame F1 includes a non-light-emitting phase and a light-emitting phase. The non-light-emitting phase includes a first reset phase. The driving module 11 is configured to drive the light-emitting element D to emit light during the light-emitting phase. The driving module 11 includes a driver transistor T1. The first reset module 12 is configured to simultaneously reset a gate of the driver transistor T1, a first electrode of the driver transistor T1, and a second electrode of the driver transistor in the first reset phase.

The light-emitting element D may include one or more of a red light-emitting element, a green light-emitting element, a blue light-emitting element, a white light-emitting element, a yellow light-emitting element, a cyan light-emitting element, a magenta light-emitting element, and is not limited herein. The light-emitting element may be a light-emitting diode, and the light-emitting diode includes, but is not limited to, an organic light-emitting diode (OLED), a mini light-emitting diode (Mini LED), or a micro light-emitting diode (Micro LED).

Specifically, with continued reference to FIG. 1, the gate of the driver transistor T1 is electrically connected to a first node N1, the first electrode of the driver transistor is electrically connected to a second node N2, and a second electrode of the driver transistor is electrically connected to the third node N3. The first reset module 12 may be simultaneously electrically connected to the first node N1, the second node N2, and the third node N3, or it may be electrically connected to only part of the nodes of the first node N1, the second node N2, and the third node N3, which may be set up according to the actual situation. FIG. 1 is only an exemplary illustration, but is not limited thereto. It is to be noted that in the present embodiment, the electrical connection referred to may be a direct connection, for example, the gate of the driver transistor is directly electrically connected to the first node N1, or the electrical connection may be an intermediate connection to other components, for example, the second electrode of the driver transistor is electrically connected to the light-emitting element D through other switches and other devices. Thus, the electrical connection relationship between the first reset module 12 and the first node N1, the electrical connection relationship between the first reset module 12 and the second node N2, and the electrical connection relationship between the first reset module 12 and the third node N3 may be a direct electrical connection or an indirect electrical connection relationship. On the premise that the core inventive point of the embodiments of the present application can be realized, and it is not explicitly stated whether the electrical connection is a direct electrical connection relationship or not, the present embodiments of the present application do not make a specific limitation on the definition of the electrical connection.

The driver transistor T1 of the driving module 11 may be an N-channel transistor or a P-channel transistor, and is not specifically limited herein. FIG. 1 exemplarily shows the driver transistor T1 as a P-channel transistor.

It is to be understood that the pixel circuit 10 may also include structures such as a compensation module 13, a data writing module 14, and a light-emitting control module (namely, a first light-emitting control module 151 and a second light-emitting control module 152), which may be set up according to the actual needs, and FIG. 1 is only an exemplary illustration.

Specifically, in the same pixel circuit 10, a complete driving cycle of the pixel circuit 10 includes at least a data writing frame F1, the data writing frame F1 includes a non-light-emitting phase and a light-emitting phase. In the non-light-emitting phase, the pixel circuit 10 may reset the potential of each node (such as the first node N1, the second node N2, and the third node N3), and write a data signal into the gate (namely, the first node N1) of the driver transistor T1. In the light-emitting phase, the driver transistor T1 generates a drive current under the action of the potential between the first power supply signal PVDD and the gate of the driver transistor T1, and provides drive current to the light-emitting element D, driving the light-emitting element D to emit light.

Further, the non-light-emitting phase includes a first reset phase, and in the first reset phase, the first reset module 12 may simultaneously reset the gate of the driver transistor, the first electrode of the driver transistor, and the second electrode of the driver transistor, that is, in the first reset phase, the first reset module 12 may simultaneously reset the first node N1, the second node N2, and the third node N3 to avoid being affected by the potential in the first node N1 in the previous frame, thereby improving the brightness change and flickering phenomenon of the light-emitting element D occurring during the light-emitting element D is driven at a low frequency. Meanwhile, the potentials of the second node N2 and the third node N2 are adjusted and reset, which can improve the effect of the characteristic offset or hysteresis of the driver transistor T1 after long-term operation, enhance the conduction bias stress of the driver transistor T1, and improve the display effect of the display panel including the pixel circuit 10.

It should be noted that the potentials of the first node N1, the second node N2 and the third node N3 may be the same or different after the first reset module 12 reset of the first node N1, the second node N2 and the third node N3, and no specific limitation is made herein. It is sufficient to ensure that after the first reset module 12 reset the first node N1, the second node N2 and the third node N3, the potentials of the first node N1, the second node N2 and the third node N3 in each data writing frame F1 are always the same as the potentials of the first node N1, the second node N2 and the third node N3 in the previous data writing frame F1.

In the present embodiment, a first reset module is provided in a pixel circuit, a driving cycle of the pixel circuit includes a data writing frame, and the non-light-emitting phase of the data writing frame includes a first reset phase. The first reset module is configured to simultaneously reset the gate of the driver transistor, the first electrode of the driver transistor, and the second electrode of the driver transistor in the first reset phase, which can avoid the potential of the gate of the driver transistor being affected by the potential of the previous frame, thereby improving the brightness change and flicker phenomenon that occur during the light-emitting element D is driven in a low-frequency. Meanwhile the potentials of the first electrode of the driver transistor and the second electrode of the driver transistor are reset, improving the effect of the characteristic offset or hysteresis of the driver transistor after a long period of time of operation, enhancing the conduction bias stress of the driver transistor, and thereby improving the display effect of the display panel including the pixel circuit.

Optionally, with continued reference to FIG. 1, the pixel circuit 10 further includes a compensation module 13, and the compensation module 13 is electrically connected between the second electrode of the driver transistor T1 and the gate of the driver transistor T1. The first reset module 12 is electrically connected to the first electrode and the second electrode of the driver transistor T1. The non-light-emitting phase further includes a threshold compensation phrase. The compensation module 13 is configured to transmit a reset signal provided by the first reset module 12 to the gate of the driver transistor T1 in a first reset phrase to reset the gate of the driver transistor T1, and compensate the gate of the driver transistor with a threshold voltage value of the driver transistor T1 in the threshold compensation phrase.

Specifically, the first reset module 12 is electrically connected to the first electrode of the driver transistor and the second electrode of the driver transistor, respectively, and can reset the second node N2 and the third node N3 in the first reset phase. The compensation module 13 is electrically connected between the first node N1 and the third node N3, enabling the compensation module 13 to be in a conductive state in the first reset phase, and enabling the reset signal written by the first reset module 12 to the third node N3 to be transmitted to the first node N1 through the conducting compensation module 13 to reset the gate of the driver transistor. It is also possible that in the first reset phrase, the first reset module 12 can simultaneously reset the first node N1, the second node N2, and the third node N3. It should be noted that the first node N1, the second node N2, and the third node N3 are written to the same reset signal, that is, the first node N1, the second node N2, and the third node N3 have the same potential, so that the influence of the potential of the first node N1 in the previous frame can be avoided, thereby improving the brightness change and flickering phenomenon occurring during the light-emitting element D is driven in a low-frequency, and while improving the influence of the characteristic offset or hysteresis of the driver transistor T1 after long-term operation.

It should be noted that the first reset phrase and the threshold compensation phrase are different time periods, and it can be understood that the first reset phrase should be prior to the threshold compensation phrase, and the compensation module 13 conducts in the first reset phrase and in the threshold compensation phrase, enabling the pixel circuitry 10 to be in different operating state to ensure that the pixel circuitry 10 can operate normally.

Optionally, continuing to refer to FIG. 1, the compensation module 13 includes a compensation transistor T2, a first electrode of the compensation transistor T2 is electrically connected to the second electrode of the driver transistor T1, a second electrode of the compensation transistor T2 is electrically connected to the gate of the driver transistor T1, a gate of the compensation transistor T2 receives a first scanning signal S1, and the first scanning signal S1 controls the compensation transistor T2 to conduct during the threshold compensation phrase and the first reset phrase.

The compensation transistor T2 may be an N-channel transistor or a P-channel transistor, which is not specifically limited herein. FIG. 1 exemplarily shows the compensation transistor T2 as an N-channel transistor.

Specifically, when the compensation transistor T2 is an N-channel transistor, the compensation transistor T2 can be controlled to conduct when the first scanning signal S1 is high. The compensation transistor T2 is controlled to turn off when the first scanning signal is low. Thus in the first reset phrase and the threshold compensation phrase, the first scanning signal S1 shall be high to control the compensation transistor T2.

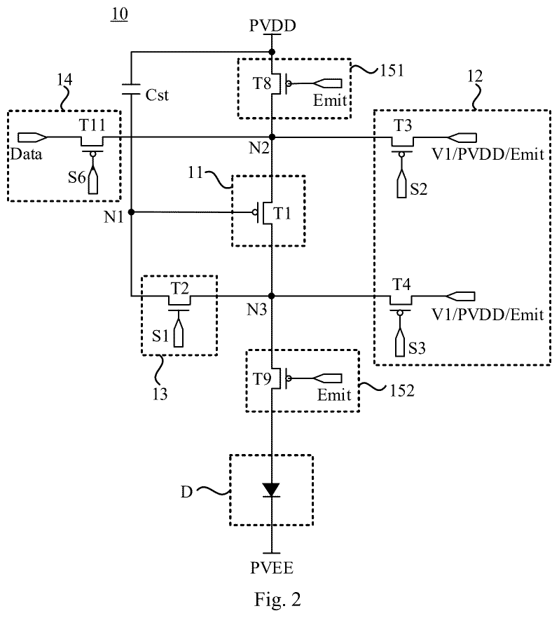

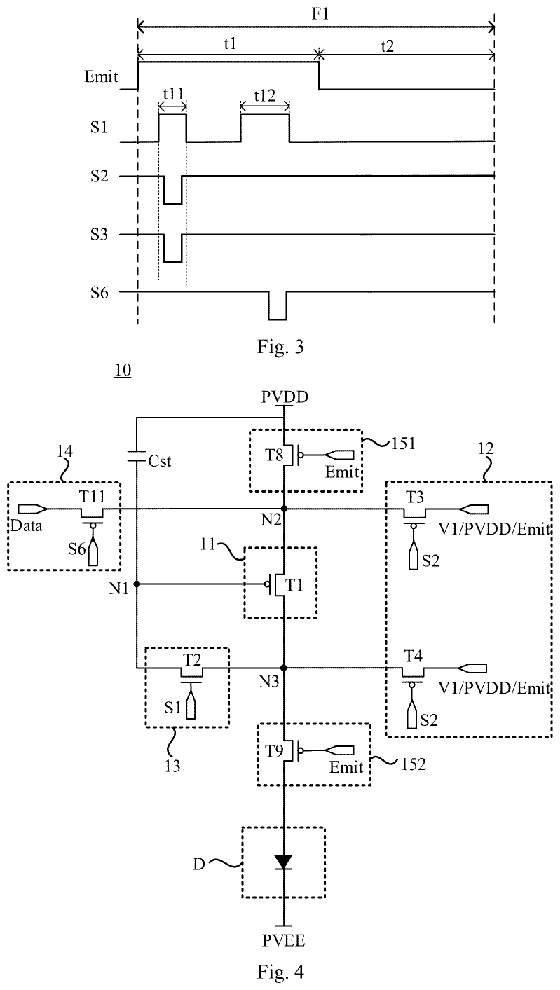

Optionally, FIG. 2 is a schematic view of another pixel circuit according to an embodiment of the present application, and FIG. 3 is a timing diagram of FIG. 2. With combined reference to FIGS. 2 and 3, the first reset module 12 comprises a first reset transistor T3 and a second reset transistor T4. A first electrode of the first reset transistor T3 receives a first reset signal V1, a second electrode of the first reset transistor T3 is electrically connected to the first electrode of the driving transistor T1, and a gate of the first reset transistor T3 receives a second scanning signal S2. The second scanning signal S2 controls at least the first reset transistor T3 to conduct in a first reset phrase t11. A first electrode of the second reset transistor T4 receives a first reset signal V1, a second electrode of the second reset transistor T4 is electrically connected to the second electrode of the driver transistor T1, a gate of second reset transistor T4 receives a third scanning signal S3, and the third scanning signal S3 controls at least the second reset transistor T4 to conduct in the first reset phrase t11.

The first reset transistor T3 and the second reset transistor T4 may be an N-channel transistor or a P-channel transistor, and are not specifically limited herein. The types of the first reset transistor T3 and the second reset transistor T4 may be the same or different, and are also not specifically limited herein.

Exemplarily, taking the example where the first reset transistor T3 and the second reset transistor T4 are P-channel transistors, and the compensation transistor T2 in the compensation module 13 is an N-channel transistor, and continuing to refer to FIGS. 2 and 3, the data writing frame F1 includes a non-light-emitting phase t1 and an light-emitting phase t2, the non-light-emitting phase t1 includes a first reset phase t11 and a threshold compensation phase t12, and the compensation transistor T2 in the compensation module 13 is conducting in the first reset phase t11 and the threshold compensation phase t12. In this way, the first scanning signal S1 is held high in the first reset phase t11 and the threshold compensation phase t12, and the first reset transistor T3 and the second reset transistor T4 are conducting at least during the first reset phase t11, that is, the second scanning signal S2 and the third scanning signal S3 are held low at least during the first reset phrase t11.

Specifically, in the first reset phrase t11, with the first reset transistor T3 and the second reset transistor T4 conducting, the first reset signal V1 can be transmitted to the first electrode (namely, the second node N2) of the driver transistor T1 via the conducting first reset transistor T3, and to the second electrode (namely, the third node N3) of the driver transistor T1 via the conducting second reset transistor T4. With the compensation module 13 in a conducting state, the first reset signal V1 written by the third node N3 can continue to be transmitted to the gate (namely, the first node N1) of the driver transistor T1. Thus in the first reset phase t11, the first reset signal V1 in the first reset module 12 can simultaneously reset the gate of the driver transistor T1, the first electrode of the driver transistor T1, and the second electrode of the driver transistor T1 to avoid being affected potential of the first node N1 in the previous frame, thereby improving the brightness change and flickering phenomenon of the light-emitting element D that occurs during the light-emitting element D is driven at a low-frequency. At the same time, the effect of the characteristic offset or hysteresis of the driver transistor T1 is improved after a long period of operation, and the conduction bias stress of the driver transistor T1 is enhanced.

It is noted that the second scanning signal S2 and the third scanning signal S3 may also control the first reset transistor T3 and the second reset transistor T4 to conduct during other time period of the non-light-emitting phase 1, such as after the threshold compensation phase t12, further adjusting the potentials of the second node N2 and the third node N3 to improve the effects of the characteristic offset or hysteresis of the driver transistor T1 after a long period of operation. In addition, the driving cycle of the pixel circuit 10 may also include a holding frame, and during partial time period of the holding frame, the second scanning signal S2 and the third scanning signal S3 can also control the first reset transistor T3 and the second reset transistor T4 to conduct to further adjust the potentials of the second node N2 and the third node N3, and to improve the effects of the characteristic offset or hysteresis of the driver transistor T1 after long-term operation. The specific conducting periods of the second scanning signal S2 and the third scanning signal S3 may be set according to the actual situation and are not specifically limited herein.

Optionally, FIG. 4 is a schematic view of another pixel circuit according to an embodiment of the present application, and the second scanning signal S2 is reused as the third scanning signal S3 as shown in FIG. 4.

Specifically, the first reset transistor T3 and the second reset transistor T4 may be controlled to conduct or turn off by the second scanning signal S2, which reduces the number of signal lines for transmitting the scanning signals, simplifies the structure, and thereby facilitates the design of the display panel with a narrow bezel.

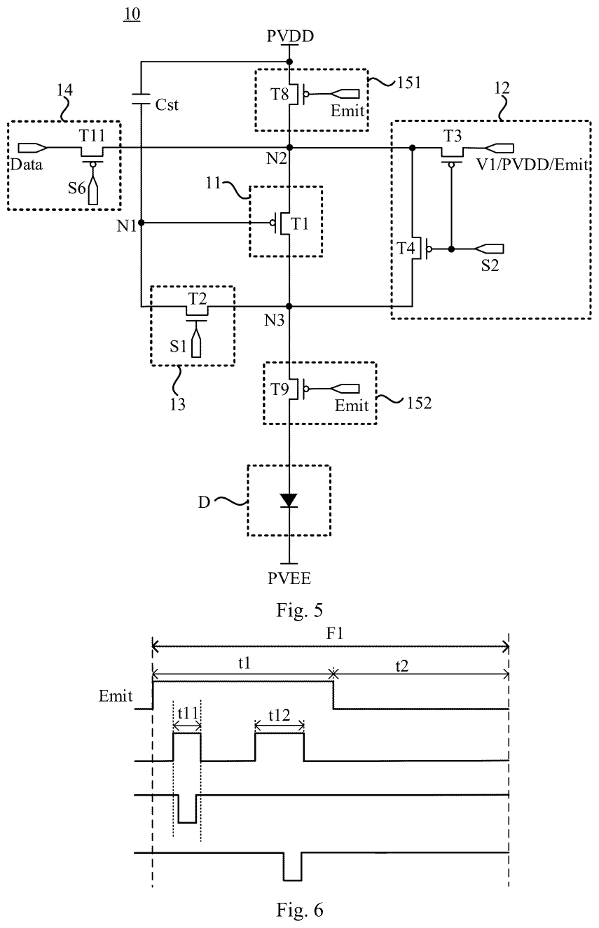

Optionally, FIG. 5 is a schematic view of yet another pixel circuit according to an embodiment of the present application, FIG. 6 is a timing diagram of FIG. 5, and as shown in combination with reference to FIGS. 5 and 6, the first reset module 12 includes a first reset transistor T3 and a second reset transistor T4. A first electrode of the first reset transistor T3 receives a first reset signal V1, a second electrode of the first reset transistor T3 is electrically connected to the first electrode of the driver transistor T1, and a gate of the first reset transistor T3 receives a second scanning signal S2. The second scanning signal S2 at least controls the first reset transistor T3 to conduct in the first reset phrase t11. A first electrode of the second reset transistor T4 is electrically connected to the second electrode of the first reset transistor T3, a second electrode of the second reset transistor T4 is electrically connected to the second electrode of the driver transistor T1, a gate of the reset transistor T4 receives the second scanning signal S2, and the second scanning signal S2 at least controls the second reset transistor T4 to conduct in the first reset phrase t11.

Exemplarily, taking the example where the first reset transistor T3 and the second reset transistor T4 are P-channel transistors and the compensation transistor T2 in the compensation module 13 is an N-channel transistor, referring to FIGS. 5 and 6, the first reset transistor T3 and the second reset transistor T4 are simultaneously controlled to conduct or turn off by the second scanning signal S2, and in the first reset phrase t11, the second scanning signal S2 is low, controlling the first reset transistor T3 and the second reset transistor T4 to conduct, so that the first reset signal V1 is transmitted to the first electrode (namely, the second node N2) of the driver transistor T1 through the conducting first reset transistor T3, and to the second electrode (namely, the third node N3) of the driver transistor T1 through the conducting first reset transistor T3 and the conducting second reset transistor T4. In addition, with the compensation module 13 conducting in the first reset phrase t11, the first reset signal V1 written by the third node N3 continues to be transmitted to the gate (namely, the first node N1) of the driver transistor T1 through the conducting compensation module 13. Thus in the first reset phrase t11, the first reset signal V1 in the first reset module 12 may simultaneously reset the gate of the driver transistor T1, the first electrode of the driver transistor T1, and the second electrode of the driver transistor T1 to avoid being affected by the potential of the first node N1 in the previous frame, thereby improving the brightness variation and flickering phenomena occurring during the light-emitting element D is driven at a low frequency. At the same time, the effect of characteristic offset or hysteresis after long-term operation is improved, and the conduction bias stress of the driver transistor T1 is enhanced.

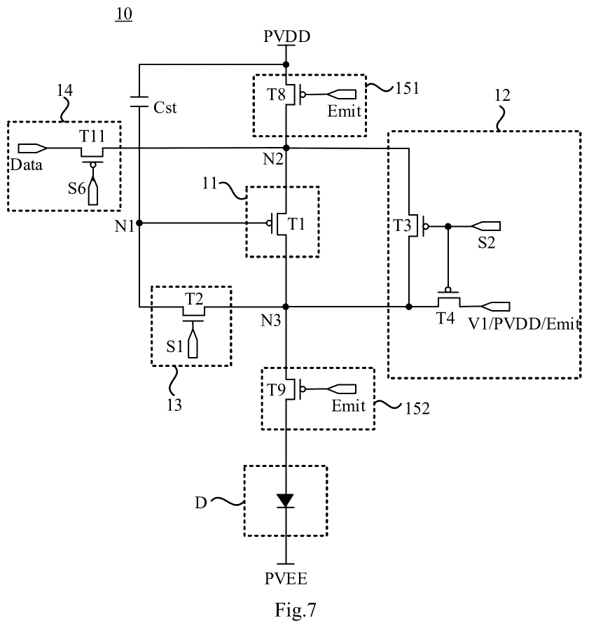

Optionally, FIG. 7 is a schematic view of another pixel circuit according to an embodiment of the present application, as shown in FIG. 7, the first reset module 12 includes a first reset transistor T3 and a second reset transistor T4. The first electrode of the first reset transistor T3 is electrically connected to a second electrode of the second reset transistor T4, the second electrode of the first reset transistor T3 is electrically connected to the first electrode of the driver transistor T1, the gate of the first reset transistor T3 receives a second scanning signal S2, and the second scanning signal S2 at least controls the first reset transistor T3 to conduct in the first reset phrase t11. The first electrode of the second reset transistor T4 receives a first reset signal V1, the second electrode of the second reset transistor T4 is electrically connected to the second electrode of the driver transistor T1, the gate of the second reset transistor T4 receives the second scanning signal S2, and the second scanning signal S2 controls at least the second reset transistor T4 to conduct in the first reset phrase t11.

Exemplarily, taking the example where the example where the first reset transistor T3 and the second reset transistor T4 are P-channel transistors, and the compensation transistor T2 in the compensation module 13 is an N-channel transistor, the driving timing of the pixel circuit corresponding to in FIG. 7 may continue to refer to FIG. 6, in the first reset phrase t11, the second scanning signal S2 is low, controlling the first reset transistor T3 and the second reset transistor T4 to conduct, so that the first reset signal V1 is transmitted to the second electrode (namely, the third node N3) of the driver transistor T1 through the conducting second reset transistor T4, and to the first electrode (namely, the second node N1) of the driver transistor T1 through the conducting second reset transistor T4 and the first reset transistor T3. In addition, with the compensation module 13 conducting in the first reset phrase t11, the first reset signal V1 written by the third node N3 continues to be transmitted to the gate (namely, the first node N1) of the driver transistor T1 through the conducting compensation module 13. Thus in the first reset phrase t11, the first reset signal V1 in the first reset module 12 can simultaneously reset the gate of the driver transistor T1, the first electrode of the driver transistor T1, and the second electrode of the driver transistor T1 to avoid being affected by the potential of the first node N1 in the previous frame, and thereby to improve the brightness change and flicker phenomenon of the light-emitting element D occurring during the light-emitting element D is driven in a low-frequency. At the same time, the effect of the characteristic offset or hysteresis of the driver transistor T1 is improved after long-term operation, and the conduction bias stress of the driver transistor T1 is enhanced.

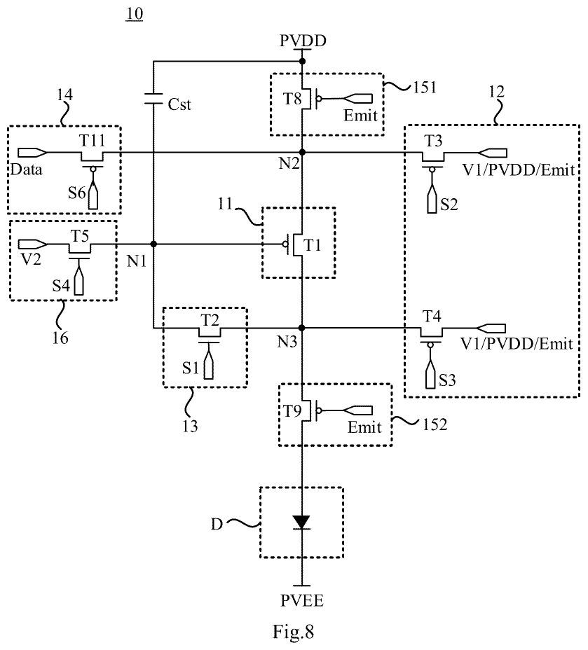

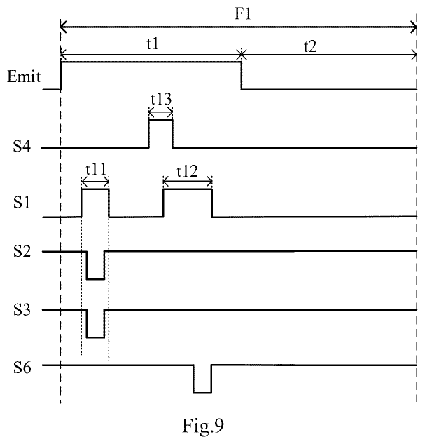

On the basis of any of the above embodiments, optionally, FIG. 8 is a schematic view of still another pixel circuit according to an embodiment of the present application, and FIG. 9 is a timing diagram of FIG. 8. As shown with combined reference to FIGS. 8 and 9, the pixel circuit 10 further includes a second reset module 16, the non-light-emitting phase t1 further includes a second reset phase t13, and the second reset module 16 is configured to drive the gate of the transistor T1 to reset in the second reset phase t13. The first reset phase t11 is prior to the second reset phrase t13, and the first reset phrase t11 and the second reset phrase t13 do not overlap each other.

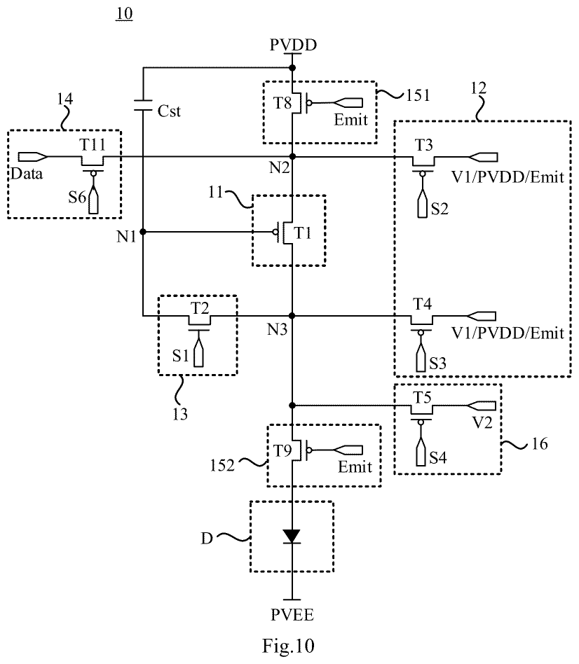

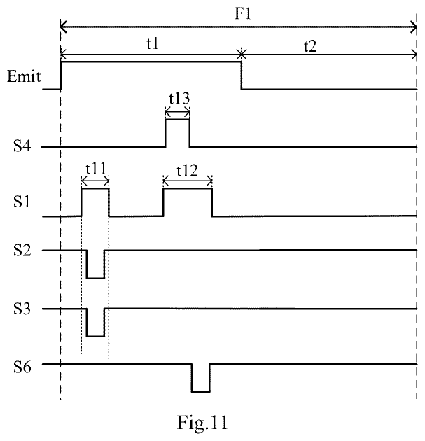

Since the second reset module 16 may reset the gate of the driver transistor T1, an electrical connection is required between the second reset module 16 and the gate of the driver transistor T1, either as shown with reference to FIG. 8, a direct electrical connection between the second reset module 16 and the gate of the driver transistor T1, or as shown with reference to FIG. 10, an indirect electrical connection between the second reset module 16 and the gate of the driver transistor T1 by other transmission modules (such as the compensation module 13), which may be set according to the actual situation.

Specifically, in the first reset phrase t11, the first reset module 12 may reset the gate of the driver transistor T1, the first electrode of the driver transistor T1, and the second electrode of the driver transistor T1 to ensure that at the end of the first reset phrase t11 of each data writing frame F1, the potentials of the first node N1, the second node N2, and the third node N3 are always the same as the potentials of the previous data writing frame F1 after reset, and to eliminate the problems such as afterimages during the light-emitting element D is driven at a low frequency. Furthermore, after the first reset phrase t11, the second reset module 16 resets the gate of the driver transistor T1 in the second reset phrase t13 to further reset the potential of the first node N1, to adjust the conduction bias stress of the driver transistor T1, and to facilitate restoration of the characteristics of the driver transistor T1.

It is to be noted that the first reset phrase t11 and the threshold compensation phrase t12 may or may not overlap, and may be set according to the actual pixel circuit structure.

In an optional embodiment, as shown with continued reference to FIGS. 8 and 9, the second reset module 12 includes a third reset transistor T5, a first electrode of the third reset transistor T5 receives a second reset signal V2, a second electrode of the third reset transistor T5 is electrically connected to the gate of the driver transistor T1, the gate of the third reset transistor T5 receives a fourth scanning signal S4, and the fourth scanning signal S4 controls the third reset transistor T5 to conduct in the second reset phrase t13.

The third reset transistor T5 may be a P-channel transistor or an N-channel transistor which is not specifically limited herein.

Exemplarily, the third reset transistor T5 illustrated in FIG. 8 is an N-channel transistor, and in the second reset phrase t13, the fourth scanning signal S4 is high, and controls the third reset transistor T5 to conduct, so that the second reset signal V2 is transmitted to the gate of the driver transistor T1 (namely, the first node N1) through the conducting third reset transistor T5 to reset the first node N1.

In another optional embodiment, FIG. 10 is a schematic view of yet another pixel circuit according to an embodiment of the present application, and FIG. 11 is a timing diagram of FIG. 10. With reference to FIG. 10 and FIG. 11, the second reset module 16 further includes a third reset transistor T5, a first electrode of the third reset transistor T5 receives a second reset signal V2, and a second electrode of the third reset transistor T5 is electrically connected to the second electrode of the driver transistor T1, and a gate of the third reset transistor T5 receives a fourth scanning signal S4, the fourth scanning signal S4 controls the third reset transistor T5 to conduct in the second reset phrase t13. The compensation module 13 is also configured to transmit the second reset signal V2 to the gate of the driver transistor T1 in the second reset phrase t13.

Exemplarily, taking the example where the third reset transistor T5 is an N-channel transistor, the fourth scanning signal S4 is high, and controls the third reset transistor T5 to conduct, enabling the second reset signal V2 to be transmitted to the second electrode (namely, the third node N3) of the driver transistor T1 through the conducting third reset transistor T5. At the same time, the compensation module 13 conducts in the second reset phrase t13, enabling the second reset signal V2 written by the third node N3 to be transmitted to the gate of the driver transistor T1 through the conducting compensation module 13 to reset the gate of the driver transistor T1.

It should be noted that since the compensation module 13 conducts only in the first reset phrase t11 and the threshold compensation phrase t12 in the non-light-emitting t1, and the first reset phrase t11 and the second reset phrase t13 do not overlap with each other. However, the threshold compensation phrase t12 is required overlap with the second reset phrase t13, that is, the second reset phrase t13 is in the same period as the partial the threshold compensation phrase t12 to ensure that the compensation module 13 conducts normally to enable the second reset signal V2 to be transmitted to the gate of the driver transistor T1.

It is to be noted that the specific structure of the first reset module 12 in the present embodiment may be set according to the actual situation, and may also be the structure shown in FIG. 4, FIG. 5, and FIG. 7. FIG. 8 and FIG. 10 are only exemplary illustrations but are not limited to herein.

Optionally, the third reset transistor T5 may also be a double-gate structure transistor, for example, the third reset transistor T5 is a P-type double-gate transistor. It may be understood that the double-gate transistor has a better leakage containment effect, and thus is able to further stabilize the potential of the first node N1, and avoid the problem of leakage at the potential of the first node N1.

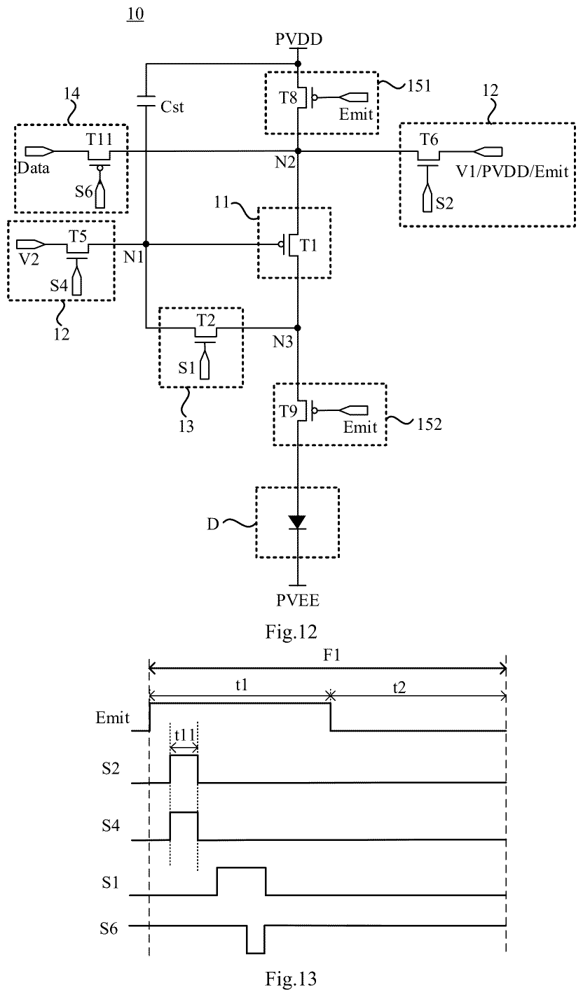

FIG. 12 is a schematic view of yet another pixel circuit according to an embodiment of the present application, FIG. 13 is a timing diagram of FIG. 12, and with reference to FIGS. 12 and 13, the first reset module 12 includes a third reset transistor T5 and a fourth reset transistor T6. A first electrode of the third reset transistor T5 receives a second reset signal V2, and a second electrode of the third reset transistor T5 is electrically connected to the gate of the driver transistor T1, a gate of the third reset transistor T5 receives a fourth scanning signal S4, and the fourth scanning signal S4 controls the third reset transistor T5 to be turned on in the first reset phrase t11. A first electrode of the fourth reset transistor T6 receives a first reset signal V1, a second electrode of the fourth reset transistor T6 is electrically connected to the first electrode or the second electrode of the driver transistor T1, a gate of the fourth reset transistor T6 receives a second scanning signal S2, and the second scanning signal S2 controls the fourth reset transistor T6 to be turned on in the first reset phrase t11.

The third reset transistor T5 and the fourth reset transistor T6 may be a P-channel transistor or an N-channel transistor, and furthermore, the types of the third reset transistor T5 and the fourth reset transistor T6 may be the same or different, and are not specifically limited herein.

Exemplarily, FIG. 12 illustrates a schematic view of a pixel circuit in which the second electrode of the fourth reset transistor T6 is electrically connected to the first electrode of the driver transistor T1. Taking the example where the third reset transistor T5 and the fourth reset transistor T6 are N-channel transistors, in the first reset phrase t11, the second scanning signal S2 and the fourth scanning signal S4 are high and control the third reset transistor T5 and the fourth reset transistor T6 to be turned on, so that the first reset signal V1 is transmitted to the first electrode (namely, the second node N2) of the driver transistor T1 through the turned-on fourth reset transistor T6, and at the same time the second reset signal V2 is transmitted to the gate (namely, the first node N1) of the driver transistor T1 through the turned-on third reset transistor T5. Thus the driver transistor T1 is turned on under the action of the first reset signal V1 and the second reset signal V2, enabling the first reset signal V1 written into the second node N2 to be transmitted to the second electrode (namely, the third node N3) of the driver transistor T1. As a result, in the first reset phrase t11, the first reset module 12 reset the gate of the driver transistor T1, the first electrode of the driver transistor T1 and the second electrode of the driver transistor T1 to avoid being affected by the potential of the first node N1 in the previous frame, and thus to improve the brightness change and flickering phenomenon of the light-emitting element D occurring during the light-emitting element D is driven at a low frequency. At the same time, the influence of the characteristic offset or hysteresis of the driver transistor T1 is improved after a long period of time of operation, and the conduction bias stress of the driver transistor is enhanced.

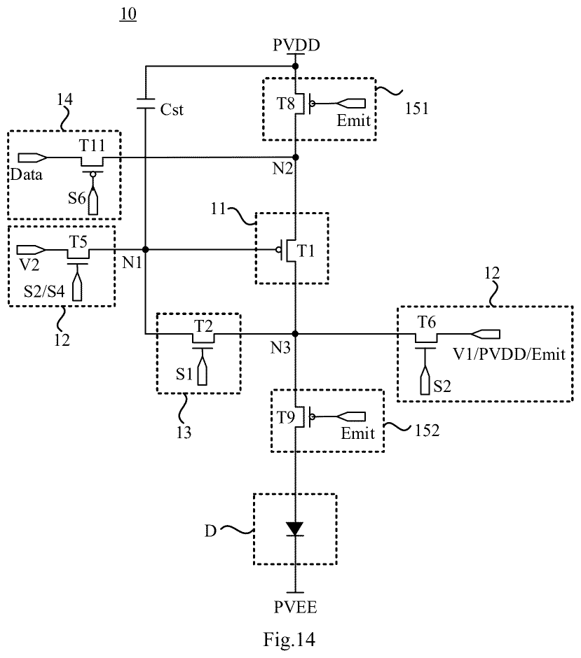

In other embodiments, FIG. 14 is a schematic view of yet another pixel circuit according to an embodiment of the present application. with reference to FIG. 14, Unlike FIG. 12, FIG. 14 exemplarily illustrates a schematic view of the structure of a pixel circuit in which the second electrode of the fourth reset transistor T6 is electrically connected to the second electrode of the driver transistor T1, and taking the example where the third reset transistor T5 and the fourth reset transistor T6 are N-channel transistors, the driving timing corresponding to the pixel circuit 10 may continue to be shown with reference to FIG. 13. In the first reset phrase t11, the second scanning signal S2 and the fourth scanning signal S4 are high, and controls the third reset transistor T5 and the fourth reset transistor T6 to be turned on, so that the first reset signal V1 is transmitted to the second electrode (namely, the third node N3) of the driver transistor T1 through the turned-on fourth reset transistor T6, and at the same time, the second reset signal V2 is transmitted to the gate of the driver transistor T1 (namely, the first node N1) through the turned-on third reset transistor T5. Thus, under the action of the first reset signal V1, the gate source voltage of the driver transistor T1 reaches a turned-on condition, thereby controlling the driver transistor T1 to be turned on, which in turn enables the first reset signal V1 written to the third node N3 to be transmitted to the first electrode of the driver transistor T1 (namely, the second node N2). As a result, in the first reset phrase t11, the first reset module 12 simultaneously resets the gate, the first electrode, and the second electrode of the driver transistor T1 to avoid being affected by the potential of the first node N1 in the previous frame, which in turn improves the brightness change and flickering phenomenon occurring during the light-emitting element D is driven at a low frequency. At the same time, the influence of the characteristic offset or hysteresis of the driver transistor T1 is improved after a long period of time of operation, and the conduction bias stress of the driver transistor T1 is enhanced.

With continued reference to FIG. 12 or FIG. 14, the pixel circuit 10 may further include a compensation module 13, the compensation module 13 may include a compensation transistor T2, and a gate of the compensation transistor T2 receives the first scanning signal S1, enabling the first scanning signal S1 to control the compensation transistor T2 to be turned on or turn off. It should be noted that in the present embodiment, in the first reset phrase t11, the first scanning signal S1 should control the compensation transistor T2 to be in the turn-off state to avoid a conflict between the second reset signal V2 written by the first node N1 and the first reset signal V1 written by the third node N3 with different voltages. Exemplarily, taking the example where the compensation transistor T2 is an N-channel transistor, in the first reset phase t11, the first scanning signal S1 is low to control the compensation transistor T2 to turn off.

Optionally, with continued reference to FIG. 12 or FIG. 14, the fourth scanning signal S4 is reused as the second scanning signal S2, so that the third reset transistor T5 and the fourth reset transistor T6 may be controlled to be turned on or turned off by the second scanning signal S2, which reduces the number of signal lines for transmitting the scanning signals, and simplifies the structure and thereby facilitates the design of the display panel with a narrow bezel.

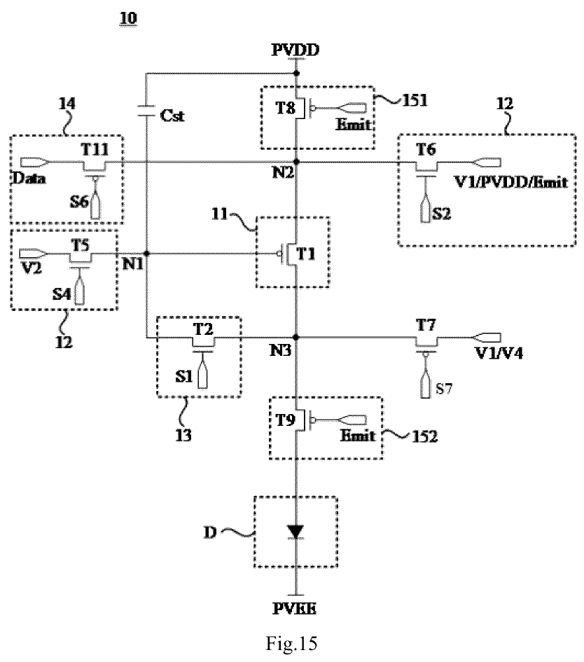

Optionally, FIG. 15 is a schematic view of yet another pixel circuit according to an embodiment of the present application, as shown in FIG. 15, on the basis of FIG. 12 or FIG. 14, the pixel circuit 10 may also include a fifth reset transistor T7, and the fifth reset transistor T7 may be a P-channel transistor or an N-channel transistor, which is not specifically limited herein. Taking the structure of the pixel circuit 10 shown in FIG. 12 as an example, a first electrode of the fifth reset transistor T7 illustrated in FIG. 15 receives a fourth reset signal V4, a second electrode of the fifth reset transistor T7 is electrically connected to the second electrode of the driver transistor T1, and a gate of the fifth reset transistor T7 receives a seventh scanning signal S7. The seventh scanning signal S7 can control the fifth reset transistor T7 to be turned on in the non-light-emitting phase, so that the fourth reset signal V4 can reset the second electrode of the driver transistor T1, thereby adjusting the bias characteristics of the driver transistor T1 and improving the problem of threshold voltage drift. In other embodiments, the structure of the pixel circuit 10 is taken as an example, unlike FIG. 15, the second electrode of the fifth reset transistor T7 is then electrically connected to the first electrode of the driver transistor T1, and during a partial time period of the non-light-emitting phase, and the seventh scanning signal S7 may control the fifth reset transistor T7 to be turned on, so that the fourth reset signal V4 may reset the second electrode of the driver transistor T1, thereby adjusting the bias characteristics of the driver transistor T1 and improving the problem of threshold voltage drift. It is to be noted that, in the present embodiment, the time period during which the seventh scanning signal S7 controls the fifth reset crystal T7 to be turned on does not overlap with the first reset phrase to ensure that the first reset module 12 normally resets the gate, the first electrode, and the second electrode of the driver transistor T1 during the first reset phrase. In addition, further optionally, the first reset signal V1 may be reused as a fourth reset signal V4 to reduce the number of signal lines for transmitting the reset signal, simplify the structure and thereby facilitate the narrow bezel design of the display panel.

On the basis of any of the above embodiments, optionally, with reference to any of the pixel circuit structures in FIGS. 1 to 15, the pixel circuit 10 further includes a first light-emitting control module 151 and a second light-emitting control module 152, the first light-emitting control module 151 includes a first light-emitting control transistor T8. A first electrode of the first light-emitting control transistor T8 receives a first power supply signal PVDD, a second electrode of the first light-emitting control transistor T8 is electrically connected to the first electrode of the driver transistor T1, and a gate of the first light-emitting control transistor T8 receives the light-emitting control signal Emit. The second light-emitting control module 152 includes a second light-emitting control transistor T9, a first electrode of the second light-emitting control transistor T9 is electrically connected to the second electrode of the driver transistor T1, a second electrode of the second light-emitting control transistor T9 is electrically connected to the anode of the light-emitting element D, and a gate of the second light-emitting control transistor T9 receives the light-emitting control signal Emit. The first reset signal V1 is reused as a first power supply signal PVDD or the light-emitting control signal Emit.

The first light-emitting control transistor T8 and the second light-emitting control transistor T9 may be a P-channel transistor or an N-channel transistor, which are not specifically limited herein.

With continued reference to FIGS. 1 to 15, in the pixel circuit 10 illustrated in any of the above embodiments, the first light-emitting control transistor T8 and the second light-emitting control transistor T9 are P-channel transistors. Therefore, in the non-light-emitting phase t1, the light-emitting control signal Emit is high, controlling the first light-emitting control transistor T8 and the second light-emitting control transistor T9 to turn off, and in the light-emitting phase t2, the light-emitting control signal Emit is low, controlling the first light-emitting control transistor T8 and the second light-emitting control transistor T9 to be turned on, enabling the driver transistor T1 to generate a drive current under the action of the first power supply signal PVDD and the potential of the gate of the driver transistor T1 and to provide a drive current to the light-emitting element D to drive the luminescent element D to emit light.

Further, the first reset signal V1 may also be reused as a first power signal PVDD or a light-emitting control signal Emit, that is, the first power signal PVDD or the light-emitting control signal Emit existing in the pixel circuit 10 is used as the first reset signal V1, which further reduces the number of signal transmission lines, thereby simplifying the structure and facilitating the design of the display panel with a narrow bezel.

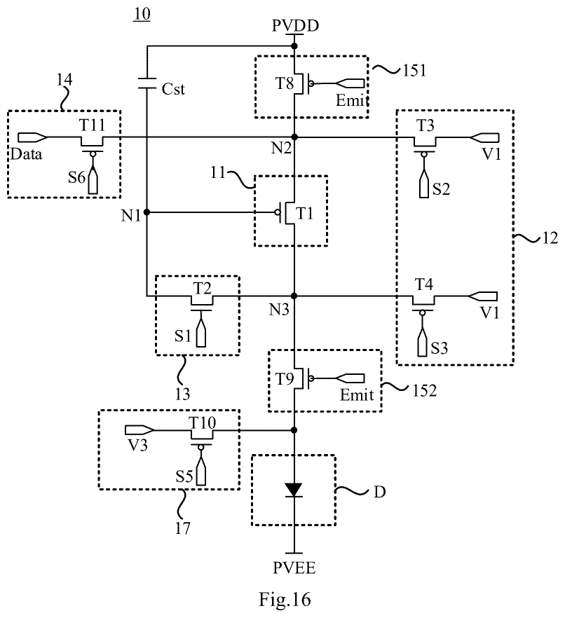

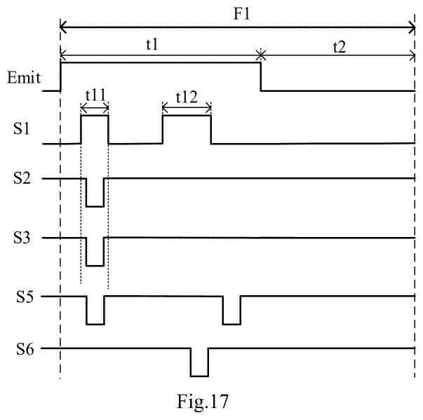

On the basis of any of the above embodiments, optionally, FIG. 16 is a schematic view of yet another pixel circuit according to an embodiment of the present application, and FIG. 17 is a timing diagram of FIG. 16. With reference to FIG. 16 and FIG. 17, the pixel circuit 10 further includes a third reset module 17, the third reset module 17 includes a sixth reset transistor T10, a first electrode of the sixth reset transistor T10 receives the third reset signal V3, a second electrode of the sixth reset transistor T10 is electrically connected to the anode of the light-emitting element D, a gate of the sixth reset transistor T10 receives a fifth scanning signal S5, and the fifth scanning signal S5 controls the sixth reset transistor T10 to be turned on during partial time period of the non-light-emitting phase t1.

The sixth reset transistor T10 may be a P-channel transistor or an N-channel transistor, which is not specifically limited herein.

Exemplarily, taking the sixth reset transistor T10 as a P-channel transistor as an example, in a case where the fifth scanning signal is low, and controls the sixth reset transistor T10 to be turned on, the third reset signal V3 is transmitted to the anode of the light-emitting element D through the turned-on sixth reset transistor T10 to reset the anode of the light-emitting element D, avoiding the influence of the voltage signal written into the light-emitting element D in the previous frame, and improving the accuracy of the luminous brightness of the light-emitting element D.

It is to be noted that the time period during which the fifth scanning signal S5 controls the sixth reset transistor T10 to be turned on may be in any time period of the non-light-emitting phase, which is not specifically limited herein, and FIG. 17 is only shown illustratively but not limited herein. In addition, the driving cycle of the pixel circuit 10 may also include a holding frame, and the fifth scanning signal S5 may control the sixth reset transistor T10 to be turned on in a partial time period of the holding frame to reset the anode of the light-emitting element D, ensuring the light-emitting accuracy of the light-emitting element D when driven in the low-frequency.

Further optionally, the time period in which the fifth scanning signal S5 controls the sixth reset transistor T10 to be turned on may include a first reset phase. In some embodiments, a scanning signal controlling transistors in the first reset module 12 to be turned on may be reused as the fifth scanning signal S5 to reduce the number of scanning signal lines. Exemplarily, with reference to FIG. 16, the second scan signal S2 may be reused as the fifth scan signal S5.

Optionally, with reference to the structural view of the pixel circuit 10 provided in any of the above embodiments, the pixel circuit 10 further includes a data writing module 14. The non-light-emitting phase further includes a data writing phase, the data writing module 14 is configured to write a data signal to the gate of the driving transistor T1 in the data writing phase. The first reset phase is prior to the data writing phase.

Specifically, the data writing module 14 writes a data signal to the gate (first node N1) of the driver transistor T1 in the data writing phase, and the first light-emitting control module 151 and the second light-emitting control module 152 be turned on in a light-emitting phase, enabling the first power supply signal PVDD to be transmitted to the first electrode of the driver transistor T1, and while enabling the cathode of the light-emitting element D to write the second power supply signal PVEE. Thus a current path is formed from the first power supply signal PVDD to the second power supply signal PVEE, enabling the driver transistor T1 to generate a drive current to drive the light-emitting element D to emit light in accordance with the voltage difference between the data signal written to the gate of the driver transistor T1 and the first power supply signal PVDD of the first electrode of the driver transistor T1.

It should be noted that the first reset phase should be prior to the data writing phase to ensure that in any two adjacent data writing frames, no matter what kind of data signal in the data writing frame is written to the gate of the driver transistor T1 in the data writing phase, the gate of the driver transistor T1 will not be affected by the data signal written to the first node N1 in the previous frame, due to the first reset module reset the gate, the first electrode, and the second electrode of the driver transistor T1 during the first reset phase of each of the data writing frames. Meanwhile, the gate of the driver transistor T1 can be prevented from being affected by the threshold voltage shift of the driver transistor T1, thereby avoiding affecting the accuracy of the light emitting brightness of the light-emitting element D, and improving the problem of afterimage.

Further optionally, on the basis of any of the above embodiments, the pixel circuit 10 further includes a storage capacitor Cst, a first electrode plate of the storage capacitor Cst receives a first power supply signal PVDD, and a second electrode plate of the storage capacitor Cst electrically connected to the gate of the driver transistor T1 for storing the potential written to the gate of the driver transistor T1.

Optionally, with continued reference to the structural view of the pixel circuit 10 provided in any of the above embodiments, the data writing module 14 includes a data writing transistor T11, a first electrode of the data writing transistor T11 receives a data signal Data, a second electrode of the data writing transistor T11 is electrically connected to a first electrode of the driving transistor T1, and a gate of the data writing transistor T11 receives a sixth scanning signal S6, and the sixth scanning signal S6 controls the data writing transistor T11 to be turned on in the data writing phase.

The data writing transistor T11 may be a P-channel transistor or an N-channel transistor, which is not specifically limited herein.

Exemplarily, taking the data writing transistor T11 as a P-channel transistor as an example, referring to FIGS. 2 and 3, in the data writing phase, the sixth scanning signal S6 is low, controlling the data writing transistor T11 to be turned on, and at the same time, the compensation module 13 is turned on in the data writing phase, so that the data signal can be transmitted to the gate of the driver transistor T1 through the turned-on driver transistor T1 and the compensation module 13 in sequence.

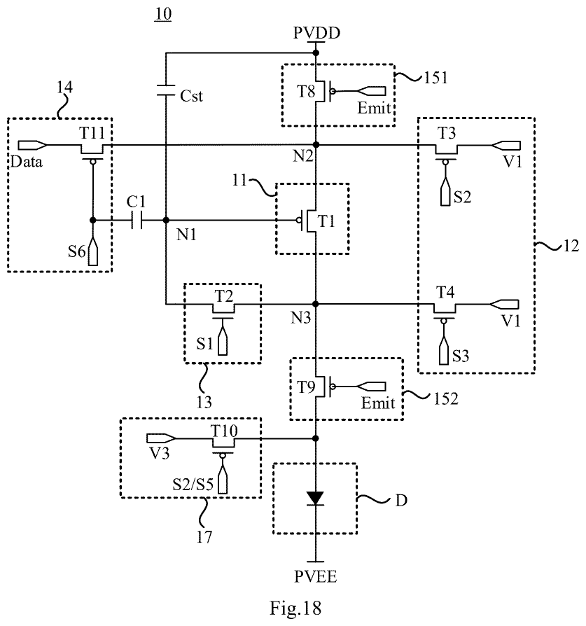

Optionally, on the basis of any of the above embodiments, FIG. 18 is a schematic view of yet another pixel circuit according to an embodiment of the present application, as shown in FIG. 18, the data writing transistor T11 includes a P-type transistor, the pixel circuit 10 further comprises a first capacitor C1, a first electrode plate of the first capacitor C1 is electrically connected to the gate of the data writing transistor T11, and the second electrode plate of the first capacitor C1 is electrically connected to the gate of the driver transistor T1.

Specifically, since the data writing transistor T11 is a P-channel transistor, when jumping from a low level to a high level, the fifth scanning signal S5 couple to and pull up the potential of the first node N1 through the first capacitor C1. When a data signal of a certain fixed voltage is written to the first node N1, compared with a structure of the pixel circuit 10 without the first capacitor C1, the voltage of the data signal supplied at the data signal end can be lowered, thereby achieving the effect of reducing power consumption.

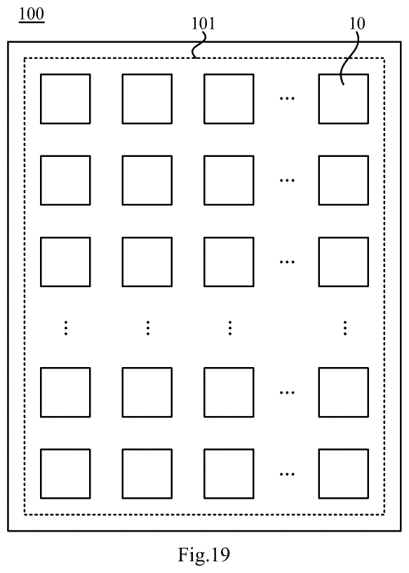

In the embodiments of the present application, a display panel is further provided, and FIG. 19 is a schematic view of a display panel according to an embodiment of the present application, as shown in FIG. 19, the display panel 100 includes a display area 101, the display area 101 includes a plurality of pixel circuits 10 arranged in an array, and the pixel circuits 10 are configured to drive a light-emitting element (not shown in the drawings) to emit light. The pixel circuit 10 is provided with a first reset module, a driving cycle of the pixel circuit includes a data writing frame, and a non-light-emitting phase of the data writing frame includes a first reset phase. The first reset module is configured to simultaneously reset the gate of the driver transistor, the first electrode of the driver transistor, and the second electrode of the driver transistor in the first reset phase, which can avoid a potential of the gate of the driver transistor being affected by a potential in the previous frame, thereby improving the brightness change and flickering phenomenon occurring during the light-emitting element D is driven in a low-frequency. Meanwhile, the potential of the first electrode of the driver transistor and the potential of the second electrode of the driver transistor are reset, improving the influence of characteristic offset or hysteresis of the driver transistor after long-term operation, and enhancing the conduction bias stress of the driver transistor, thereby improving the display effect of the display panel 100 comprising the pixel circuit 10.

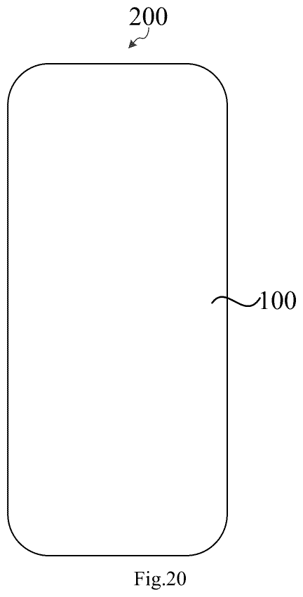

In addition, a display device is further provided in the embodiments of the present application. FIG. 20 is a schematic view of a display device according to an embodiment of the present application. As shown in FIG. 20, the display device 200 includes the display panel 100 provided in any embodiment of the present application, and the display device 200 provided in embodiments of the present application may be a cellular phone, and may be any electronic product with a display function, including but not limited to the following category: television sets, notebook computers, desktop monitors, tablet computers, digital cameras, smart bracelets, smart glasses, in-vehicle displays, medical devices, industrial control devices, touch interaction terminals, and the like, to which the embodiments of the present application are not specifically limited.

What is claimed is:

1. A pixel circuit, comprising:
a driving module comprising a driver transistor;
a first reset module; and
a light-emitting element,
wherein a driving cycle of the pixel circuit comprises a data writing frame, the data writing frame comprising a non-light-emitting phase and a light-emitting phase, and the non-light-emitting phase comprising a first reset phase; and
the drive module is configured to drive the light-emitting element to emit light in the light-emitting phase, and the first reset module is configured to simultaneously reset a gate of the driver transistor, a first electrode of the driver transistor, and a second electrode of the driver transistor in the first reset phase.

2. The pixel circuit according to claim 1, further comprising a compensation module electrically connected between the second electrode of the driver transistor and the gate of the driver transistor,
wherein the first reset module is electrically connected to the first electrode and the second electrode of the driver transistor, and
the non-light-emitting phase further comprises a threshold compensation phase, and the compensation module is configured to transmit a reset signal provided by the first reset module to the gate of the driver transistor in the first reset phase to reset the gate of the driver transistor, and is configured to compensate the gate of the driver transistor with a threshold voltage value of the driver transistor in the threshold compensation phase.

3. The pixel circuit according to claim 2, wherein the compensation module comprises a compensation transistor, a first electrode of the compensation transistor being electrically connected to the second electrode of the driver transistor, a second electrode of the compensation transistor being electrically connected to the gate of the driver transistor, and a gate of the compensation transistor receiving a first scanning signal that controls the compensation transistor to be turned on in the threshold compensation phase and the first reset phase.

4. The pixel circuit according to claim 2, wherein the first reset module comprises a first reset transistor and a second reset transistor, wherein
a first electrode of the first reset transistor receives a first reset signal, a second electrode of the first reset transistor is electrically connected to the first electrode of the driver transistor, and a gate of the first reset transistor receives a second scanning signal that controls at least the first reset transistor to be turned on in the first reset phase; and
a first electrode of the second reset transistor receives the first reset signal, a second electrode of the second reset transistor is electrically connected to the second electrode of the driver transistor, and a gate of the second reset transistor receives a third scanning signal that controls at least the second reset transistor to be turned on in the first reset phase.

5. The pixel circuit according to claim 4, wherein the second scanning signal is reused as the third scanning signal.

6. The pixel circuit according to claim 2, wherein the first reset module comprises a first reset transistor and a second reset transistor, wherein
a first electrode of the first reset transistor receives a first reset signal, a second electrode of the first reset transistor is electrically connected to the first electrode of the driver transistor, and a gate of the first reset transistor receives a second scanning signal that controls at least the first reset transistor to be turned on in the first reset phase; and
a first electrode of the second reset transistor is electrically connected to the second electrode of the first reset transistor, a second electrode of the second reset transistor is electrically connected to the second electrode of the driver transistor, and a gate of the second reset transistor receives the second scanning signal that controls at least the second reset transistor to be turned on in the first reset stage.

7. The pixel circuit according to claim 2, wherein the first reset module comprises a first reset transistor and a second reset transistor, wherein
a first electrode of the first reset transistor is electrically connected to a second electrode of the second reset transistor, a second electrode of the first reset transistor is electrically connected to the first electrode of the driver transistor, and a gate of the first reset transistor receives a second scanning signal that controls at least the first reset transistor to be turned on in the first reset phase; and
a first electrode of the second reset transistor receives a first reset signal, a second electrode of the second reset transistor is electrically connected to the second electrode of the driver transistor, and a gate of the second reset transistor receives the second scanning signal that controls at least the second reset transistor to be turned on in the first reset phase.

8. The pixel circuit according to claim 7, further comprising a second reset module,
wherein the non-light-emitting phase further comprising a second reset phase, and the second reset module is configured to reset the gate of the driver transistor in the second reset phase; and
the first reset phase is prior to the second reset phase, and the first reset phase and the second reset phase do not overlap each other.

9. The pixel circuit according to claim 8, wherein the second reset module comprises a third reset transistor,
wherein a first electrode of the third reset transistor receives a second reset signal, a second electrode of the third reset transistor is electrically connected to the gate of the driver transistor, and a gate of the third reset transistor receives a fourth scanning signal that controls the third reset transistor to be turned on in the second reset phase.

10. The pixel circuit according to claim 8, wherein the second reset module comprises a third reset transistor,
wherein a first electrode of the third reset transistor receives a second reset signal, a second electrode of the third reset transistor is electrically connected to the second electrode of the driver transistor, and a gate of the third reset transistor receives a fourth scanning signal that controls the third reset transistor to be turned on in the second reset stage; and
the compensation module is further configured to transmit the second reset signal to the gate of the driver transistor in the second reset phase.

11. The pixel circuit according to claim 7, wherein the first reset module further comprises a third reset transistor and a fourth reset transistor, wherein
a first electrode of the third reset transistor receives a second reset signal, a second electrode of the third reset transistor is electrically connected to the gate of the driver transistor, and a gate of the third reset transistor receives a fourth scanning signal that controls the third reset transistor to be turned on in the first reset stage; and
a first electrode of the fourth reset transistor receives a first reset signal, a second electrode of the fourth reset transistor is electrically connected to the first or second electrode of the driver transistor, and a gate of the fourth reset transistor receiving a second scanning signal that controls the fourth reset transistor to be turned on in the first reset stage.

12. The pixel circuit according to claim 11, wherein the fourth scan signal is reused as the second scan signal.

13. The pixel circuit according to claim 11, wherein the pixel circuit further comprising
a first light-emitting control module comprising a first light-emitting control transistor, a first electrode of the first light-emitting control transistor receiving a first power signal, a second electrode of the first light-emitting control transistor being electrically connected to the first electrode of the driver transistor, and a gate of the first light-emitting control transistor receiving a light-emitting control signal; and
a second light-emitting control module comprising a second light-emitting control transistor, a first electrode of the second light-emitting control transistor being electrically connected to the second electrode of the driving transistor, a second electrode of the second light-emitting control transistor being electrically connected to an anode of the light-emitting element, and a gate of the second light-emitting control transistor receiving the light-emitting control signal,
wherein the first reset signal is reused as a first power signal or a light-emitting control signal.

14. The pixel circuit according to claim 1, further comprising a third reset module comprising a sixth reset transistor, a first electrode of the sixth reset transistor receiving a third reset signal, a second electrode of the sixth reset transistor being electrically connected to an anode of the light-emitting element, and a gate of the sixth reset transistor receiving a fifth scanning signal that controls the sixth reset transistor to be turned on during a partial time period of the non-light-emitting phase.

15. The pixel circuit according to claim 1, further comprising a data writing module,
wherein the non-light-emitting phase further comprises a data writing phase, and the data writing module is configured to write a data signal to the gate of the driver transistor in the data writing phase; and
the first reset phase is prior to the data writing stage.

16. The pixel circuit according to claim 15, wherein the data writing module comprises a data writing transistor, a first electrode of the data writing transistor receiving a data signal, a second electrode of the data writing transistor being electrically connected to the first electrode of the driver transistor, and a gate of the data writing transistor receiving a sixth scanning signal that controls the data writing transistor to be turned on in the data writing phase.

17. The pixel circuit according to claim 16, wherein the data writing transistor comprises a P-type transistor, and the pixel circuit further comprises a first capacitor, a first electrode plate of the first capacitor electrically connected to a gate of the data writing transistor, and a second electrode plate of the first capacitor electrically connected to the gate of the driver transistor.

18. A display panel, comprising a pixel circuit which comprises:
a driving module comprising a driver transistor;
a first reset module; and
a light-emitting element,
wherein a driving cycle of the pixel circuit comprises a data writing frame, the data writing frame comprising a non-light-emitting phase and a light-emitting phase, and the non-light-emitting phase comprising a first reset phase; and
the drive module is configured to drive the light-emitting element to emit light in the light-emitting phase, and the first reset module is configured to simultaneously reset a gate of the driver transistor, a first electrode of the driver transistor and a second electrode of the driver transistor in the first reset phase.

19. A display device, comprising a display panel that comprises a pixel circuit, the pixel circuit comprising:
a driving module comprising a driver transistor;
a first reset module; and
a light-emitting element,
wherein a driving cycle of the pixel circuit comprises a data writing frame, the data writing frame comprising a non-light-emitting phase and a light-emitting phase, and the non-light-emitting phase comprising a first reset phase; and
the drive module is configured to drive the light-emitting element to emit light in the light-emitting phase, and the first reset module is configured to simultaneously reset a gate of the driver transistor, a first electrode of the driver transistor and a second electrode of the driver transistor in the first reset phase.
